(19) United States
(12) Patent Application Publication
(10) Pub. No.: US 2021/0016222 A1
(43) Pub. Date: Jan. 21, 2021

(54) FOULING MITIGATION IN ALKANOLAMINE TREATING SYSTEMS

(71) Applicant: ExxonMobil Research and Engineering Company, Annandale, NJ (US)

(72) Inventors: Gordon Bryce McGarvey, Sarnia (CA); Robert J. Falkiner, Brampton (CA); Jesus Moreira del Rio, Calgary (CA); David R. Slim, Sarnia (CA)

(21) Appl. No.: 16/930,750

(22) Filed: Jul. 16, 2020

Related U.S. Application Data
(60) Provisional application No. 62/875,135, filed on Jul. 17, 2019.

(51) Int. Cl. B01D 53/52; B01D 53/14; B01D 53/78; C01B 17/22; C10G 75/04

(52) U.S. Cl. CPC B01D 53/526; B01D 53/1462; B01D 53/1493; B01D 53/1425; B01D 53/78; C10G 2300/4075; C10G 75/04; B01D 2252/20405; B01D 2252/20484; B01D 2252/20421; B01D 2251/304; C01B 17/22

(57) ABSTRACT

Methods for the prevention or mitigation of fouling in amine-treating systems comprising providing circulating aqueous amine solution and a hydrocarbon stream comprising at least one acid gas; and interacting the circulating aqueous amine solution with the hydrocarbon stream comprising the at least one acid gas to remove the acid gas from the hydrocarbon stream and entrain the acid gas into the aqueous amine solution. The circulating aqueous amine solution comprises entrained acid gas comprises foulant precursors; and polysulfide ions are introduced to react with the foulant precursors to decrease the rate of fouling within the circulating aqueous amine solution.

### CROSS REFERENCE TO RELATED APPLICATIONS

This application claims priority to U.S. Provisional Application Ser. No. 62/875,135 filed Jul. 17, 2020, which is herein incorporated by reference in its entirety.

### FIELD

The present disclosure relates to mitigation of fouling in amine-treating systems.

### BACKGROUND

Fouling in chemical or refinery amine units, or the deposition of unwanted material on to solid surfaces, is a major economic and operational problem. Fouling is caused by a number of processes including various chemical reactions such as polymerization of contaminants, foaming/carryover, corrosion, and the deposit of materials rendered insoluble by polymerization or the temperature difference between the process stream and a colder surface, such as a heat exchanger wall. A common cause of fouling is attributable to the presence of salts, particulates, chemical reaction products (e.g., organic polymers) and impurities (e.g., inorganic contaminants) found in crude oil streams. For example, iron oxide/sulfide, calcium carbonate, silica, sodium chloride, and calcium chloride have all been found to attach directly to surfaces in petroleum refinery operations.

As insoluble deposits build up on heat transfer equipment and other components of amine units, the deposits create an unwanted insulating effect. Fouling of systems results in additional energy costs and increased inefficiencies, including a reduction in run-lengths of alkanolamine absorbers and regenerators. To combat fouling, heat transfer equipment must be taken offline regularly and cleaned mechanically and/or chemically, resulting in operational downtime. Additionally, disposal of the undesired fouling by-product polymer is costly, and presents industrial hygiene problems. Amine polymers, sometimes called “amine taffy,” typically have very high and obnoxious odors that are undesirable and contribute to handling problems and refinery odors.

### SUMMARY

The present disclosure relates to a method to mitigate fouling and, more specifically, methods for employing polysulfide ions to decrease the rate of foulant formation.

A method can comprise providing circulating aqueous amine solution, and interacting the circulating aqueous amine solution with polysulfide ions; wherein the circulating aqueous amine solution further comprises foulant precursors, and wherein the polysulfide ions react with the foulant precursors to decrease the rate of polymerization and form aqueous soluble products.

A method of generating polysulfide ions in situ may comprise providing a polysulfide generation unit, dissolving elemental sulfur inside the polysulfide generation unit, and installing the polysulfide generation unit in an amine treating system.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one of ordinary skill in the art and having the benefit of this disclosure.

FIG. 1 is a schematic diagram of a type of amine-treating system according to certain embodiments.

FIG. 2 shows a Fourier-transform infrared spectroscopy (“FTIR”) spectra comparison of lab generated foulant and foulant collected from an active amine unit.

### DETAILED DESCRIPTION

The present disclosure relates to fouling mitigation and, more specifcally, methods for employing polysulfide ions to decrease the rate of foulant formation.

As discussed above, fouling in amine-treating systems has a severely negative economic and operational impact. Fouling reduces the run durations of alkanolamine absorbers and regenerators, and disposal of fouling byproducts is costly, and presents industrial hygiene problems. By significantly reducing the fouling rate, vessel run durations between cleaning may be increased, and waste disposal issues may be eased.

Amine foulant growth occurs by several reactions with multiple sequences possible for some reaction steps. It is known that amine fouling in light-end amine units may be caused by interactions between aldehydes and ketones, aqueous amine, diolefins, and sulfur compounds, among others, wherein those compounds react to form a polymer-like foulant that can deposit on vessel surfaces. In some cases, aldehydes, ketones, and dienes present in low concentrations in an amine system may also react to cause foulant formation. Although dimes are primarily soluble in hydrocarbon, increased pressure in some parts of the amine system (e.g., a wash drum section) directionally drive more dienes into the amine phase.

Although fouling is most severe on the lean side of lean/rich exchangers, fouling may also be present in absorber towers, regenerator trays, the rich side of lean/rich exchangers, reboilers, and other system components. Fouling is not instant when reactants combine in the absorber tower at low temperatures; rather, the rate of polymerization is a function of monomer concentration and temperature. Temperature change plays a role, as equipment in the lowest temperature areas typically undergo increased fouling. Temperature change also promotes dehydration, which lowers solubility. At high enough concentrations, soluble polymers will precipitate (foul) due to lower solubility at lower temperatures. After foulant formation, a temperature drop of any degree or any polymerization that further reduces solubility (e.g., the formation of insoluble trimers) may cause foulant to adhere on equipment surfaces.

Several chemical additive systems have been suggested to reduce or eliminate fouling in an amine treatment system with limited success. By way of example, many methods have been focused on scavenging carbonyl groups to interrupt oligomerization. However, it is believed that the oligomerization reactions proceed rapidly, leaving a window of time that is too short for additives (e.g., hydroxylamine sulfate), to react, and polymerization thus cannot be sufficiently prevented. The present disclosure approaches fouling management in amine treating systems by targeting low molecular weight polymer accumulation after it has formed, but before it exceeds the solubility limit that leads to precipitation and deposition.

Other prior mitigation strategies include introducing an aromatic or wash solvent into amine-treating systems to dissolve polymer that has formed before or after accumulation on system component surfaces. The resulting mixture of solvent and dissolved polymers may then be separated from the amine solution. Examples of solvents employed include heating oil or steam cracked naphtha. However, the aromatic solvent strategy has been found to be only partially successful, that is, only a portion of polymers are dissolved, thus a large problem with fouling remains.

The present disclosure describes a new and highly effective method to mitigate fouling in amine treatment systems involving introduction of polysulfide ions, including, but not limited to, in situ generation of poly sulfide ions from elemental sulfur addition. The method was evaluated through laboratory simulations of commercial alkanolamine operations and was found to significantly reduce fouling rate in olefin unit alkanolamine systems.

Without wishing to be limited by theory, it is believed that the polysulfide ions react with the aldehyde and ketone components monomers or aqueous soluble oligomers, interrupting the polymerization mechanism that contributes to fouling. The mitigation strategy is economical, as polysulfide ions can be produced at a low cost by adding elemental sulfur to any rich and lean alkanolamine, including ethanolamine (MEA), which is commonly used in chemical amine units and is applicable to refinery amine units. The resulting mitigation will significantly reduce operating and maintenance costs in amine treating units.

Accordingly, the present disclosure describes processes and systems that may be suitable for mitigating or reducing fouling before the formation of fouling polymers, More specifically, the present disclosure describes interacting polysulfide ions with a circulating aqueous amine solution that contains foulant precursors. The polysulfide ions may react with foulant precursors to decrease the rate of polymerization and form soluble products. Because polysulfide ions may be sourced inexpensively, the fouling rate may be significantly reduced at a very low cost. Thus, vessel run durations may be extended, expensive polymer separation equipment may play a smaller role in the overall foulant management strategy, and industrial hygiene and polymer disposal issues may be ameliorated.

In particular embodiments, fouling mitigation may be facilitated by the addition of an aqueous solution of an alkali metal polysulfide. In some or other embodiments, polysulfide ions are created in situ. In embodiments where the polysulfide ions are created in situ, the ions may be generated electrochemically, of from suitable chemical oxidation, or from the addition of elemental sulfur.

All numerical values within the detailed description and the claims herein are modified by “about” or “approximately” with respect to the indicated value, and take into account experimental error and variations that would be expected by a person having ordinary skill in the art. Unless otherwise indicated, room temperature is about 25° C.

As used in the present disclosure and claims, the singular forms “a,” “an,” and “the” shall include plural forms unless the context clearly dictates otherwise.

The term “and/or” as used in a phrase such as “A and/or B” herein is intended to include “A and B,” “A or B,” “A”, and “B.”

The term “hydrocarbon” refers to a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different numbers of carbon atoms. The term “Cₙ” refers to hydrocarbon(s) or a hydrocarbon group having n carbon atom(s) per molecule or group, wherein n is a positive integer. Such hydrocarbon compounds may be one or more of linear, branched, cyclic, acyclic, saturated, unsaturated, aliphatic, or aromatic.

The term “fouling” generally refers to the accumulation of unwanted materials on the surfaces of processing equipment or the like.

As used herein, a reduction in or mitigation of fouling is generally achieved when fewer particulates adhere to equipment surfaces, thereby mitigating their impact on the promotion of the fouling of amine treating systems.

Reference will now be made to various aspects of the present invention in view of the definitions above.

In certain embodiments, methods for preventing or mitigating fouling in amine-treating systems are described. The methods comprise providing a circulating aqueous amine solution containing foulant precursors, and interacting the circulating aqueous amine solution with polysulfide ions. The polysulfide ions may react with the foulant precursors to decrease the rate of polymerization and form soluble products.

In illustrative embodiments, the circulating aqueous amine solution may be comprised of alkanolamines. In more specific embodiments, the alkanolamines may be ethanolamine. In some or other embodiments, the alkanolamines may comprise monoethanolamine (MEA), diethanolamine (DEA), diglycolamine (DGA), di-isopropanolamine, diisopropylamine (DIPA), methyldiethanolamine (MDEA), triethanolamine (TEA), 2-amino-2-methyl-1-propanol (AMP), piperazine (PZ), or combinations of the same.

In certain embodiments, the circulating aqueous amine solution may comprise diolefins, including, by way of example, conjugated 1,3-butadiene and conjugated C5 dienes. In other or the same embodiments, the circulating aqueous amine solution comprises aldehydes, including, by way of example, one or more of methanal, ethanal, propanal and butanal and ketones, by way of example, one or more of propanone and butanone.

In certain embodiments, polysulfides may be introduced into an amine-treating system, or they may be generated in situ, or a combination of both approaches may be utilized. Introduction of polysulfides into the amine-treating system may be carried out through the addition of an aqueous solution of an alkali metal polysulfide or an organic polysulfide. The organic polysulfide may be an organic alkyl polysulfide or an organic aryl polysulfide. In certain embodiments, the aqueous solution of an alkali metal polysulfide comprises the alkali metal polysulfide sodium tetrasulfide.

In certain embodiments, in situ generation of polysulfide ions may be carried out electrochemically. The electrochemical generation of polysulfide ions may be carried out by the anodic oxidation of hydrosulfide ions. The electrochemical generation of polysulfide ions may be carried out using electrochemical cell, electrochemical membrane cell or a suitable chemical oxidation unit for the oxidation of H₂S into polysulfides. Appropriate alkaline conditions for electrode reactions may generally be within the normal operating ranges of the amine treatment processes, therefore polysulfide ions may be incorporated without significant changes to the process, and without high additive cost.

In various embodiments, the in situ generation of polysulfide ions may be accomplished by the addition of elemental sulfur. The elemental sulfur may be in the form of one or more of block sulfur, sulfur dust, wettable sulfur, water dispersible granule sulfur, wettable powder sulfur, prilled sulfur, sulfur blocks, colloidal sulfur, liquid flowable sulfur, or another suitable form of elemental sulfur known to those skilled in the art.

After disruption of polymerization by the polysulfide ions, the polymer precursors and their reaction products with polysulfide ions remain in the circulating aqueous amine solution as soluble products. In certain embodiments, the resulting soluble products may be removed by means of thermal reclaiming. In some or other embodiments, the resulting soluble product in the circulating aqueous amine solution may be removed via solution cleaning. In still other embodiments, the soluble product may be partially replaced with fresh amine.

In certain embodiments, the resulting concentration of polysulfide ions in the amine treating system is from about 50 to about 5000 weight parts per million. In other embodiments, the resulting concentration of polysulfide ions in the amine treating system is from about 100 to about 500 weight parts per million. In still other embodiments, the resulting concentration of polysulfide ions in the amine treating system is from about 50 to about 500 weight parts per million.

Provided below are example experiments of fouling and fouling mitigation. The experiments are given by way of example, and are not meant to be limiting.

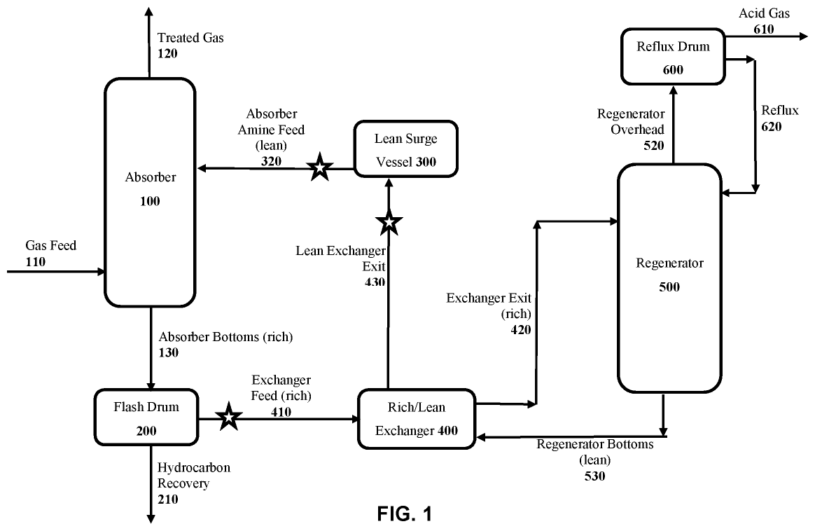

A typical amine treating system used to remove sulfur compounds, generally H₂S, and other acid gases e.g. carbon dioxide and alkyl thiols from hydrocarbon (gaseous or liquid) streams is shown in FIG. 1. The amine stream is an aqueous amine stream. FIG. 1 shows the interconnections between absorber 100, used to remove acid gases from gas feed 110, and regenerator 500, used to remove the acid gases from the recycled amine treating liquid. Gas feed 110 is known as a sour gas, meaning that it is hydrocarbon feed that contains unwanted acid gas. In order to remove the acid gas from the gas stream before sale or further processing, gas feed 110 is fed into absorber 100 where it interacts with an amine stream supplied to absorber 100 through absorber amine feed 320. Absorber amine feed 320 is a “lean” amine stream, meaning that amine feed 320 is substantially free of acid gas. Within absorber 100 the amine reacts and entrains the acid gas in gas feed 110 and exits absorber 100 as absorber bottoms 130, which is now a “rich” amine containing an increased level of acid gas. The treated gas 120 exits the top of absorber 100, and treated gas 120 is a sweet gas, containing reduced acid gas suitable for sale or further processing. Absorber bottoms 130 enters flash drum 200 to allow any entrained hydrocarbons from the feed to be removed as hydrocarbon recovery 210. The remaining material exits flash drum 200 as exchanger feed 410 to enter the rich/lean exchanger 400. The rich/lean exchanger 400 separates the acid gas-rich amine from acid gas-lean amine, sending acid gas rich amine through exchanger exit 420 and on to regenerator 500, and sending acid gas-lean amine through exchanger exit 430 and on to lean surge vessel 300. The acid gas-rich amine enters regenerator 500 where the acid gas is stripped from the amine so that acid gas exits through regenerator overhead 520 and an amine-lean steam exits through regenerator bottoms 530. Regenerator overhead 520 enters reflux drum 600 where any entrained amine is separated from the acid gas, such that the acid gas exits through acid gas line 610 and the separated amine is returned to regenerator 500 through 620. The acid gas-lean amine in exchanger exit 430 enters lean surge vessel 300 before being fed through absorber amine feed line 320 into absorber 100. In this example system, a sour gas feed is then treated using a recycled amine to create a sweet gas product and an acid gas byproduct.

FIG. 1 illustrates a circulating aqueous amine solution wherein aqueous amine enters absorber 100 a lean amine and exits absorber 100 a rich amine. Considering the system as a whole, the stream from regenerator bottoms 500, through rich/lean exchanger 400, on to exchanger exit 430 onto lean surge vessel 300 and on to absorber 100 through absorber fee 320 can be considered the “lean amine circuit.” By contrast, the stream from absorber bottoms 130, through flash drum 200, then through exchanger feed 410 to rich/lean exchanger 400, then through exchanger exit 420 onto regenerator 500 can be considered the “rich amine circuit.”

The stars shown in FIG. 1 indicate preferred locations for the introduction of polysulfide ions. These locations are suitable for any of the above-described method of generating polysulfide ions. As shown, the polysulfide ions may be introduced into the rich amine circuit into exchanger feed 410 before the feed enters rich/lean exchanger 400. In other embodiments, it may be desirable to introduce the polysulfide ions into the lean amine circuit, either into exchanger exit 430 before that stream enters surge vessel 300 or into absorber amine feed line 320 before that stream enters absorber 100. In some systems, it may be preferable to introduce the polysulfide ions into the lean amine circuit versus the rich side. In some systems it may be particularly preferable to introduce the polysulfide ions into the lean amine circuit through absorber amine feed line 320 before that stream enters absorber 100.

In order to determine factors sufficient to cause fouling under conditions similar to the pressure and temperature conditions of an amine regeneration tower, various experimental matrices were executed. Experiments were carried out in an autoclave unit at 30 psia and 90° C. in a nitrogen inert atmosphere. Results of the experiments showed that amine fouling may result from the reaction of aldehydes and diolefins in an amine solution.

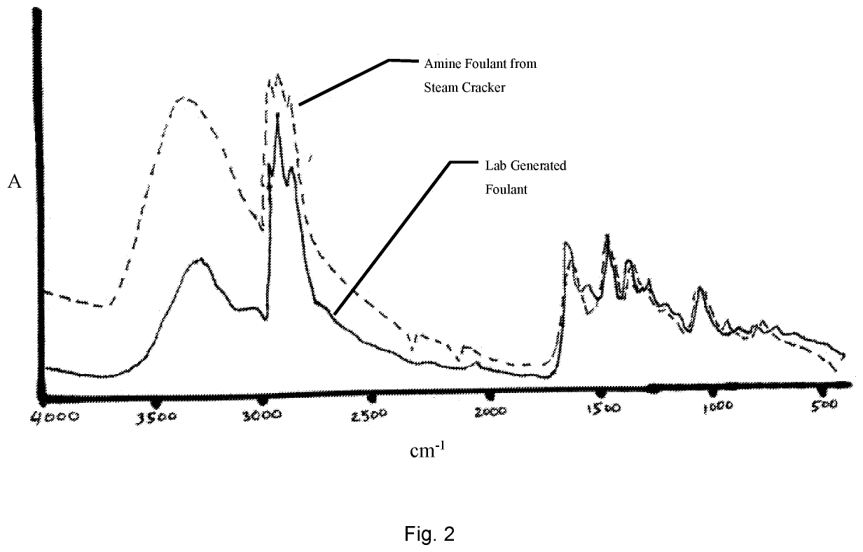

In various experimental matrices, described for purposes of example, monoethanolamine (MEA) was used as the representative amine solution, the aldehyde was a cis/trans mixture of crotonaldehyde, and the diolefin was 2,3-dimethyl-1,3-butadiene. In various experiments, 600 mL of 20 wt. % MEA was variously analyzed alone, or with the addition of one or both of 3.5 milliliters 0.5 wt. % and 4 milliliters 0.5 wt. % 2,3-dimethyl-1,3-butadiene. Only in experiments where both aldehydes and diolefins were present did foulant form in the MEA solution. Laboratory formed foulant was compared to foulant sample from a light-end treating unit in a steam cracker using Fourier-transform infrared spectroscopy (FTIR), and the resulting composition profiles were very similar, indicating that both samples had the same structural composition, as illustrated in FIG. 2.

Laboratory experiments were performed to determine the influence of polysulfide ions on amine polymer formation. In experiments where polysulfide ions were present, amine fouling was reduced. Aqueous amine solutions comprising one or more aldehydes and one or more diolefins were optionally treated with the addition of 0.17 wt. % sulfur. Addition of sulfur resulted in the formation of polysulfide ions. In experiments where sulfur was added to the aqueous amine solution, foulant formation was prevented, that is, no polymer foulant was formed, for a residence time of 8 hours. In experiments of longer duration (e.g., 100 hours, polymer foulant formation was significantly reduced with the addition of polysulfide ions relative to experiments where polysulfide was not added.

Embodiments disclosed herein include:

A first example embodiment is a method for the prevention or mitigation of fouling in amine-treating systems comprising providing circulating aqueous amine solution; and interacting the circulating aqueous amine solution with polysulfide ions; wherein the circulating aqueous amine solution further comprises foulant precursors; and wherein the polysulfide ions react with the foulant precursors to decrease the rate of polymerization and form soluble products.

A second example embodiment is a method of generating polysulfide ions in situ comprising providing a polysulfide generation unit; dissolving elemental sulfur inside the polysulfide generation unit; and installing the polysulfide generation unit in an amine treating system.

The first example embodiment can include one or more of the following: Element 1:wherein the aqueous amine solution comprises alkanolamines; Element 2: Element 1 and wherein the alkanolamines comprise ethanolamines; Element 3: Element 1 and wherein the alkanolamines comprise diethanolamine, diglycolamine, di-isopropanolamine and/or methyldiethanolamine; Element 4: wherein the circulating aqueous amine solution comprises diolefins; Element 5:Element 4 and wherein the diolefins comprise conjugated 1,3-butadiene and C5 dienes; Element 6: wherein the circulating aqueous amine solution comprises aldehydes; Element 7: Element 6 and wherein the aldehydes comprise one or more of methanol, ethanal, propanal and butanal; Element 8: wherein the circulating aqueous amine solution comprises ketones; Element 9: Element 8 and wherein the ketones comprise one or more of propanone and butanone; Element 10: wherein the polysulfide ions are formed from an addition of an aqueous solution of an alkali metal polysulfide or an organic polysulfide, where theorganic polysulfide may be an organic alkyl polysulfide or an organic aryl polysulfide; Element 11: Element 10 and wherein the alkali metal polysulfide is sodium tetrasulfide; Element 12: wherein the polysulfide ions are created in situ; Element 13: wherein the polysulfide ions comprise polysulfide ions generated electrochemically; Element 14: wherein the polysulfide ions comprise polysulfide ions generated from addition of elemental sulfur; Element 15: Element 14 and wherein the elemental sulfur is selected from the group consisting of block sulfur, sulfur dust, wettable sulfur, water dispersible granule sulfur, wettable powder sulfur, prilled sulfur, sulfur blocks, colloidal sulfur, liquid flowable sulfur, and combinations thereof; Element 16: wherein the circulating aqueous amine solution further comprises soluble products; and where the soluble products are removed by means of thermal reclaiming, solution cleansing or partial replacement with fresh amine.

Examples of combinations of elements of the first example embodiment include, but are not limited to: Element 1 in combination with one or more of Element 2-12; Element 2 in combination with one or more of Element 4-12; Element 3 in combination with one or more of Element 4-12; Element 4 in combination with one or more of Element 5-12; Element 5 in combination with one or more of Element 6-12; Element 6 in combination with one or more of Element 7 and/or Element 10-12; Element 7 in combination with one or more of Element 10-12 and/or Element 16; Element 8 in combination with one or more of Element 10, 11 and/or 16; Element 9 in combination with one or more of Element 10, 11 and/or 16; Element 10 in combination with one or more of Element 11 and/or 16; Element 11 in combination with Element 16; Element 12 in combination with Element 13-16; Element 13 in combination with Element 16; Element 14 in combination with one or more of Element 15-16; and Element 15 in combination with Element 17.

The second example embodiment can include one or more of the following: Element 17: wherein the polysulfide generation unit introduces polysulfide ions circulating into the amine treating system at a concentration of from about 50 to about 5000 weight parts per million; Element 18: wherein the polysulfide generation unit introduces polysulfide ions circulating into the amine treating system at a concentration of between from about 100 to about 500 weight parts per million; Element 19: wherein the amine treating system comprises a rich amine circuit; and wherein the to polysulfide generation unit is installed on the rich amine circuit; Element 20: wherein the amine treating system comprises a rich amine circuit; and wherein direct polysulfide addition is added to the rich amine circuit; Element 21: wherein the amine treating system comprises a lean amine circuit; and wherein the polysulfide generation unit is installed on the lean amine circuit; Element 22: wherein the amine treating system comprises a lean amine circuit; and wherein the direct polysulfide addition is added to the lean amine circuit.

Examples of combinations of elements of the second example embodiment include, but are not limited to: Element 17 in combination with one or more of Element 19-22; and Element 18 in combination with one or more of Element 19-22.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed, including the upper and lower limit. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A method for the prevention or mitigation of fouling in amine-treating systems comprising:
providing circulating aqueous amine solution and a hydrocarbon stream comprising at least one acid gas; and
interacting the circulating aqueous amine solution with the hydrocarbon stream comprising the at least one acid gas to remove at least a portion of the acid gas from the hydrocarbon stream and entrain the acid gas into the aqueous amine solution;
wherein the circulating aqueous amine solution comprising entrained acid gas comprises foulant precursors; and
introducing polysulfide ions react with the foulant precursors to decrease the rate of fouling within the circulating aqueous amine solution.

2. The method of claim 1 wherein the circulating aqueous amine solution comprises a rich amine circuit and a lean amine circuit; and wherein polysulfide ions are introduced into the rich amine circuit, the lean amine circuit, or both the rich amine circuit and the lean amine circuit.

3. The method of claim 1, wherein the aqueous amine solution comprises alkanolamines.

4. The method of claim 3, wherein the alkanolamines comprise at least one ethanolamine selected from the group consisting of monoethanolamine (MEA), diethanolamine (DEA), diglycolamine (DGA), di-isopropanolamine, diisopropylamine (DIPA), methyldiethanolamine (MDEA), triethanolamine (TEA), 2-amino-2-methyl-1-propanol (AMP), piperazine (PZ), and combinations thereof.

5. The method of claim 1, wherein the circulating aqueous amine solution comprises diolefins.

6. The method of claim 5, wherein the diolefins comprise conjugated 1,3-butadiene and C₅ dienes.

7. The method of claim 1, wherein the circulating aqueous amine solution comprises aldehydes.

8. The method of claim 7, wherein the aldehydes comprise at least one material selected from the group consisting of methanal, ethanal, propanal, butanal, and combinations thereof.

9. The method of claim 1, wherein the circulating aqueous amine solution comprises ketones.

10. The method of claim 9, wherein the ketones comprise one or more of propanone and butanone.

11. The method of claim 1, wherein the polysulfide ions are formed from an addition of an aqueous solution of one of an alkali metal polysulfide and organic polysulfide.

12. The method of claim 11, wherein the alkali metal polysulfide is sodium tetrasulfide.

13. The method of claim 1, wherein the polysulfide ions are created in situ.

14. The method of claim 13, wherein the polysulfide ions comprise polysulfide ions generated by electrochemical generation.

15. The method of claim 13, wherein the polysulfide ions comprise polysulfide ions generated from addition of elemental sulfur.

16. The method of claim 15, wherein the elemental sulfur is selected from the group consisting of block sulfur, sulfur dust, wettable sulfur, water dispersible granule sulfur, wettable powder sulfur, prilled sulfur, sulfur blocks, colloidal sulfur, liquid flowable sulfur, and combinations thereof.

17. The method of claim 1, wherein the circulating aqueous amine solution further comprises soluble products; and where the soluble products are removed by means of thermal reclaiming, solution cleansing or partial replacement with fresh amine.

18. A method of generating polysulfide ions in situ comprising:
providing a polysulfide generation unit;
dissolving elemental sulfur inside the polysulfide generation unit; and installing the
polysulfide generation unit in an amine treating system.

19. The method of claim 18, wherein the polysulfide generation unit introduces polysulfide ions circulating into the amine treating system at a concentration of from about 50 to about 5000 weight parts per million.

20. The method of claim 18, wherein the polysulfide generation unit introduces polysulfide ions circulating into the amine treating system at a concentration of between from about 100 to about 500 weight parts per million.

21. The method of claim 18, wherein the amine treating system comprises a rich amine circuit and a lean amine circuit; and wherein the polysulfide generation unit is installed on the rich amine circuit, the lean amine circuit, or both the rich amine circuit and the lean amine circuit.

22. The method of claim 18, wherein the amine treating system comprises a rich amine circuit and a lean amine circuit; and wherein direct polysulfide addition is added to the rich amine circuit, the lean amine circuit, or both the rich amine circuit and the lean amine circuit.
